(19) United States
(12) Patent Application Publication
(10) Pub. No.: US 2017/0271938 A1
(43) Pub. Date: Sep. 21, 2017

(54) SEGMENTED COMPONENT WITH A FIRST SHAPED PART

(71) Applicant: SIEMENS AKTIENGESELLSCHAFT, München (DE)

(72) Inventor: Norbert WÖHNER, Heustreu (DE)

(73) Assignee: Siemens Aktiengesellschaft, München (DE)

(21) Appl. No.: 15/309,702

(22) PCT Filed: Apr. 22, 2015
(86) PCT No.: PCT/EP2015/058710

§ 371 Date: Nov. 8, 2016

(30) Foreign Application Priority Data
May 9, 2014 (EP) 14167729.4

(51) Int. Cl. H02K 5/06; B22D 19/00; B22D 19/04; H02K 15/14; H02K 5/18

(52) U.S. Cl. CPC H02K 5/06; H02K 15/14; H02K 5/18; B22D 19/04; B22D 19/0063; B22D 17/00

(57) ABSTRACT

A segmented component for a housing includes a first shaped part, a first segment having a first cast metal region which is material-bonded to the first shaped part by a first bonding zone. The first shaped part is material-bonded to a second cast metal region of a second segment by a second bonding zone. At least one additional element is material-bonded to the second segment by a third bonding zone and material-bonded to the first segment by a fourth bonding zone, wherein the first shaped part, the first and second segments, and the at least one additional element defining an extension of an interior space of the housing in a cross-sectional plane.

The invention relates to a segmented component according to the preamble of claim 1, a segment with a shaped part for the segmented component, a shaped part for the segmented component and a machine, in particular an electric machine which comprises the segmented component. Furthermore, the invention relates to a method for manufacturing the segmented component, and a use of the shaped part for the segmented component.

A segmented component is known from US 2004/0012284 A1 in the form of a segmented machine housing. There it is established that housing made of cast or forged metal may have minor inclusions or defects in the wall areas of the housing the remedying of which is a time-consuming and expensive process. In addition, difficulties occur during casting if deep holes with a constant cross-section are to be manufactured with precise dimensions. In such cases, it may be necessary to perform further processing steps to obtain sufficiently high precision of the dimensions. To overcome such problems, some motor housings are produced by means of extrusion. With extrusion, a block of an aluminum alloy or other metal is pushed through a die of a fixed size and shape. The dimensions produced by extrusion are more precise than with usual casting processes but manufacturing using extrusion has limitations under which it is difficult to produce a hollow extrusion with a large diameter. US 2004/0012284 A1 therefore suggests producing a multiplicity of segments with coolant channels running in a longitudinal direction by means of extrusion, casting or forging and connecting these to a housing with a large internal diameter by means of mechanical bond, a welded seam or a suitable adhesive.

In US 2004/0012284 A1, a segmented component is used for a housing of an electric machine. The electric machine comprises a stator which is fastened to an internal surface of the housing. In the aforementioned publication, the segmented component is typically a part of a housing which fixes and supports one or more bearings which receive the shaft and support the rotor in its bearing inside the stator, wherein the electric machine furthermore has bearing shields at each end of the segmented component which center and fix the shaft with the aid of the bearings.

Due to the inadequacies described, it is therefore the task of the invention to make a technical contribution with which a segmented component can be made available economically and in high quality.

The object is achieved by a segmented component with the features of claim 1.

A segmented component according to the invention comprises
a first segment and a second segment,
wherein the segmented component has a first shaped part which extends in an axial direction,
wherein the first segment has a first cast metal region,
wherein the second segment has a second cast metal region,
wherein the first cast metal region is material-bonded to the first shaped part by means of a first bonding zone and the first shaped part is material-bonded to the second cast metal region by means of a second bonding zone.

The object is also achieved by a segment with a shaped part.

In a segment according to the invention with a shaped part for a segmented component according to the invention, the segment is the first segment and the shaped part the first shaped part, wherein the first cast metal region is material-bonded to the first shaped part by the first bonding zone.

The object is also achieved by a shaped part.

A shaped part according to the invention for a segmented component according to the invention is the first shaped part.

The object is also achieved by a machine, in particular an electric machine, with the features as claimed in claim 14.

A machine according to the invention, in particular an electric machine, comprises a segmented component according to the invention, wherein the machine has a stator which is frictionally fixed in the segmented component according to the invention by way of a frictional bond between at least one surface on an outer periphery of the stator and one internal surface of the segmented component for the operation of the machine.

The object is also achieved by a manufacturing method with the features as claimed in claim 15.

In a method according to the invention for manufacturing a segmented component according to the invention, the first cast metal region is material-bonded to the first shaped part by means of a first bonding zone and the second cast metal region is material-bonded to the first shaped part by means of a second bonding zone.

Furthermore, the object is also achieved by using a shaped part with the features as claimed in claim 16.

In a use according to the invention of a shaped part according to the invention for a segmented component according to the invention, the shaped part is used as the first shaped part for material-bonding of the first cast metal region to the first shaped part by means of a first bonding zone and for material-bonding of the first shaped part to the second cast metal region by means of a second bonding zone.

The object is achieved advantageously according to the invention by enabling the provision of a segmented component economically and in a high quality as a result of the material-bonding of the first segment to the first shaped part by the first bonding zone and the material-bonding of the first shaped part to the second cast metal region by the second bonding zone. Advantageously, due to their smaller size compared with the segmented component, the first and the second cast metal region can be economically manufactured with lower material and manufacturing costs in high quality by means of casting and economically material-bonded in high quality to a shaped part which is economical to produce. The cost of materials is, for example, advantageously low because the smaller size of the cast metal regions results in the manufacturing costs of the casting molds being lower. The manufacturing costs are, for example, therefore advantageously low because economically produced metal regions for economical bond of the two segments in high quality are sufficient at connection points between the first and the second segment as a result of casting.

The first cast metal region and if necessary, one or more additional cast metal regions advantageously present on a product according to the invention can be advantageously produced economically in a high quality by means of pressure die-casting. Inter alia, this is advantageous because the cast metal regions of products according to the invention may be smaller compared to a segmented component according to the invention and consequently, manufacturing with pressure die-casting is economically feasible. As a result of the advantageous feasibility of manufacturing by means of pressure die-casting, an advantageously high quality can be achieved, for example, in the dimensions, of a segmented component.

The first segment may mainly consist of the first cast metal region. Thus, economically advantageously the first segment may be cast in one piece.

The second segment may mainly consist of the second cast metal region. Thus, economically advantageously, the second segment may be cast in one piece.

The first shaped part may have a finer structure than the first cast metal region. Thus, economically advantageously, the first shaped part can be manufactured as a prefabricated part with another method using a deformation process and be made available or used for products and methods according to the invention. For products according to the invention, for example, the first and the second cast metal region may have pores or cavities as a result of casting. The finer structure of the first shaped part may have pores of a smaller size as a result of being manufactured using the other method.

The shaped part may mainly consist of one material. Thus, advantageously and economically, a piece of the material can be used as the starting point for manufacturing the first shaped part as the piece predominantly fills the volume of the first shaped part. Thus, advantageously only small amounts of additional materials or none at all must be attached to the first shaped part. Small amounts of materials may, for example, be attached during the manufacturing of the first shaped part by coating the surface of the first shaped part with an additional material.

A cross-sectional plane is spanned by a first radial direction and a second radial direction, an axial direction running vertically to the cross-sectional plane. A three-dimensional object which extends in an axial direction has many cross-sectional planes (theoretically, an infinite number) which are arranged in parallel to each another in an axial direction and in which the three-dimensional object can be variously embodied. Thus, for example, the first segment, the second segment and the first shaped part may extend in an axial direction which runs vertically to a cross-sectional plane of the segmented component. A particular cross-sectional plane has a particular axial position which can be indicated by an axial coordinate of a coordinate system which indicates the distance of the particular position in an axial direction from the origin of the coordinate system.

A segment according to the invention with a shaped part can be advantageously used for a segmented component according to the invention with the associated advantage. Also advantageously, as a result of the shaped part the segment according to the invention with the shaped part already has a first end which enables material-bonding economically in high quality to a second segment. There may, for example, be a time lag between the manufacture of a segment according to the invention with the shaped part and the manufacture of a material bond of this shaped part with the second segment, without an exposed surface at the first end of the segment according to the invention having significantly worse bonding properties with the shaped part than with the immediate manufacture of this material bond with the second segment. A segment according to the invention with a shaped part may have an additional bond point for bond to additional segments. Advantageously, apart from the shaped part for bond to the second segment, a segment according to the invention with a shaped part may have an additional shaped part at all the additional connection points to additional segments which according to the invention is material-bonded by means of a bonding zone with to a cast metal region of a segment according to the invention with a shaped part. Thus, for example, a time lag may exist between the manufacture of a segment according to the invention with the shaped part and the manufacture of material bonds at all connection points to segments without an exposed surface at the first end of the segment according to the invention having significantly worse bonding properties with the shaped part than in the immediate manufacture of these material bonds with the segments.

A shaped part according to the invention can be used advantageously for a segmented component according to the invention or a segment according to the invention with a shaped part with the associated advantages. Also advantageously, a shaped part according to the invention can be prefabricated economically in high quality independently of the manufacture of the segmented component. The prefabricated shaped parts can be stored economically advantageously and be used at an economical time for the manufacture of a segment according to the invention with a shaped part or a segmented component according to the invention.

A machine according to the invention also has the additional advantage that the stator can be frictionally fixed economically advantageously in a high quality in the segmented component by way of a frictional bond between at least one surface on the periphery of the stator and an internal surface of the segmented component for the operation of the machine. Advantageously, the machine may have a housing which comprises the segmented component.

For the operation of a machine according to the invention, the rotor is rotated around an axis of rotation and on a shaft to which the rotor is fastened mechanical energy can be released to a mechanical consumer in the form of a rotary motion. The forces occurring in the process result in counterforces in the stator which is fixed in the segmented component.

For the operation of a machine according to the invention, mechanical energy can also be supplied to the machine by way of the shaft, which also results in corresponding counterforces on the stator.

For a machine according to the invention, the shaft can be supported with the aid of a first bearing device in a first bearing shield and with the aid of a second bearing device in a second bearing shield.

A method according to the invention for manufacturing a segmented component also has the additional advantage that additional costly operations can be foregone with the method. Costly operations are, for example, welding or bonding of parts of the segmented component or the attachment of additional variously shaped extensions to the segmented component.

A shaped part according to the invention may be advantageously used with a shaped part for a segmented component according to the invention or a segment according to the invention with the associated advantages.

Advantageous embodiments of the invention are specified in the dependent claims.

Thus, an embodiment of a segmented component according to the invention is advantageous in which the first cast metal region is cast from a first material, in particular by means of pressure die-casting, and in the first bonding zone the first shaped part is fused by means of the first material. Thus, the first bonding zone can be economically advantageously produced in a high quality together with the first cast metal region.

In a further advantageous embodiment of a segmented component according to the invention, the first shaped part has a second material and the first bonding zone has an alloy wherein the alloy has the first and the second material. Thus, economically advantageously the first shaped part can be advantageously firmly bonded in a high quality to the first cast metal region.

In a further advantageous embodiment of a segmented component according to the invention the first shaped part has a third material in a region adjacent to the first bonding zone. Thus, economically advantageously in a high quality the first shaped part can be advantageously firmly bonded to the first cast metal region through the fusion of a coating on a surface of the first shaped part. A shaped part according to the invention for this embodiment has the coating. The additional material for the coating of the surface of the shaped part is the second material and the material of which the shaped part mainly consists is the third material. The coating can advantageously cover an exposed surface of the shaped part advantageously and economically in a high quality. An embodiment of a segment according to the invention with a shaped part is also accordingly advantageous, wherein the shaped part has a coated first shaped part. An embodiment of a segment according to the invention with a shaped part is also accordingly advantageous, which apart from the coated first shaped part for bond to the second segment has a respective coated additional shaped part at all the additional connection points to additional segments.

The coating methods with which conductors of a second material are provided with a coating on their surface in the patent application with the publication number EP 2396872 A1 can be used for the manufacture of the shaped part.

Economically advantageously, the same coating methods in a high quality can be used for the conductors of a cage rotor and for the shaped parts according to the invention of a segmented component for an electric machine according to the invention.

With regard to an electric machine with a cage rotor, the coated conductors used for this, and the manner in which the coating is applied to the conductors, and the associated coating methods, reference is made to the publication with the number EP 2396872 A1, the contents of which is hereby included in this application.

In a further advantageous embodiment of a segmented component according to the invention, a form closure is present between the first cast metal region and the first shaped part along a section of the first bonding zone. Thus, greater forces can be absorbed economically advantageously in a high quality between the first segment and the first shaped part without the bond between the first segment and the first shaped part being destroyed. Advantageously, a portion of the forces taking effect between the first segment and the first shaped part is absorbed by the form closure so that the material bond of the first bonding zone advantageously only has to accept a portion of the forces.

The section with the form closure may at least extend along half the length of the first bonding zone, wherein the length of the first bonding zone is measured along a transition area of the first shaped part on a side facing the first cast metal region in the cross-sectional plane. Thus, the forces acting on the form closure can be converted economically advantageously in a high quality into major compression forces which act advantageously within the first material of the first cast metal region and within the material of the first shaped part of which the first shaped part mainly consists. For this purpose, the form closure can economically advantageously have a dovetail groove in a high quality in the first cast metal region or in the first shaped part.

In a further advantageous embodiment of a segmented component according to the invention the first shaped part has a structure for the enlargement of a transition area on a side facing the first cast metal region. Thus, economically advantageously greater forces can be absorbed in a high quality between the first segment and the first shaped part as these are distributed over a larger area of the first bonding zone of the first shaped part which is bonded to the transition area of the first shaped part. To this end, the structure for enlargement of a transition area can advantageously be an easily produced grooved structure.

In a further advantageous embodiment of a segmented component according to the invention, by means of the first segment, the first shaped part, the second segment and at least one additional element the segmented component specifies an extension of an interior space of a housing in a cross-sectional plane of the housing, wherein the additional element is material-bonded to the second segment by a third bonding zone and is material-bonded to the first segment by a fourth bonding zone. Thus, two open ends of the segmented component can be advantageously and economically material-bonded in a high quality with a small casting mold by casting a cast metal region. If the at least one additional element is precisely one additional element then it consists of a second shaped part which is designed like a shaped part according to the invention. If the at least one additional element consists of several additional elements, then this consists of either a segment according to the invention with a first and a second shaped part, or an additional segmented component according to the invention with two additional shaped parts according to the invention, wherein one of the additional shaped parts according to the invention is material-bonded to the first segment by the fourth bonding zone and the second of the additional shaped parts according to the invention is material-bonded to the second segment by the third bonding zone. One of the additional shaped parts according to the invention is material-bonded to an additional segment on a first end of the additional segmented component according to the invention by a fifth bonding zone and the second of the additional shaped parts according to the invention is material-bonded to an additional segment on a second end of the additional segmented component according to the invention by a sixth bonding zone. The first end and the second end relates to an extension of the additional segmented component according to the invention in a cross-sectional plane of the additional segmented component according to the invention.

In a further advantageous embodiment of a segmented component according to the invention, the first and the second segment determine the shape of the segmented component in the cross-sectional plane between a first end and a second end of the segmented component. Thus, economically advantageously in a high quality a shaped part according to the invention can be used to manufacture variously shaped segmented components. The shaped parts can always have the same shape and the same dimensions and be advantageously produced in large quantities in a manufacturing process. Advantageously, various lengths of segmented components can be manufactured in an axial direction with the same shaped parts as the length of the shaped parts can be economically reduced accordingly in a simple manner.

In a further advantageous embodiment of a segmented component according to the invention, forces between the first and the second segment can be predominantly absorbed by the first cast metal region on the cross-sectional plane of the segmented component. Thus, a force-transferring bond can be produced economically advantageously in a high quality between the first and the second segment by casting the first cast metal region.

In a further advantageous embodiment of a segmented component according to the invention, forces between the first and the second segment are predominantly absorbed by the first shaped part on the cross-sectional plane of the segmented component. Thus, a high force-transferring bond can be economically advantageously material-bonded between the first and the second segment in a high quality by way of the first shaped part by means of the first and second bonding zone.

The first segment can only be bonded to the second segment by way of the shaped part. Thus, a force-transferring bonding quality can be economically advantageously adjusted in a high quality between the first and the second segment.

The first and the second cast metal region can overlap the first shaped part. Thus, the shaped part can be economically advantageously protected in a high quality.

In the previous description of the advantageous embodiments of a segmented component according to the invention, the part of the segmented component to which the first segment and the first bonding zone and its/their environment relate was described for the embodiments. Accordingly, the advantageous embodiments of the segmented component also describe the advantageous embodiments of a segment according to the invention with a shaped part, wherein the first segment corresponds to a segment of the segment according to the invention with a shaped part and the first shaped part corresponds to the shaped part of the segment according to the invention with a shaped part. Furthermore, a segmented component can be economically provided in high quality if the second cast metal region and the second bonding zone correspond to the first cast metal region and the first bonding zone of the described advantageous embodiments of a segmented component according to the invention.

In addition, advantageous embodiments of segmented components according to the invention, segments according to the invention with a shaped part, shaped parts according to the invention, machines according to the invention, methods according to the invention for manufacturing a segmented component, and uses according to the invention of a shaped part result advantageously from a combination of some or several described features.

The aforementioned properties, features and advantages of this invention and the way in which these are achieved become clearer and easier to understand in connection with the following description of the exemplary embodiments which are explained in more detail in connection with the figures. The figures show:

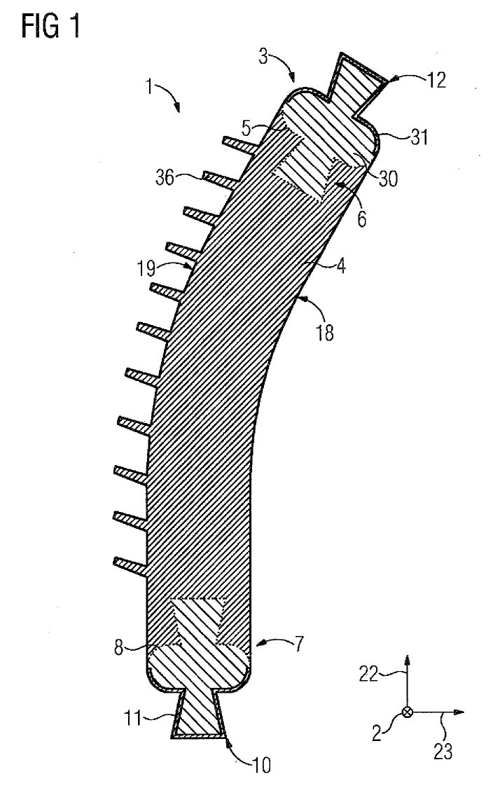

FIG. 1 a section through a cross-sectional plane of an exemplary embodiment of a segment with a shaped part,

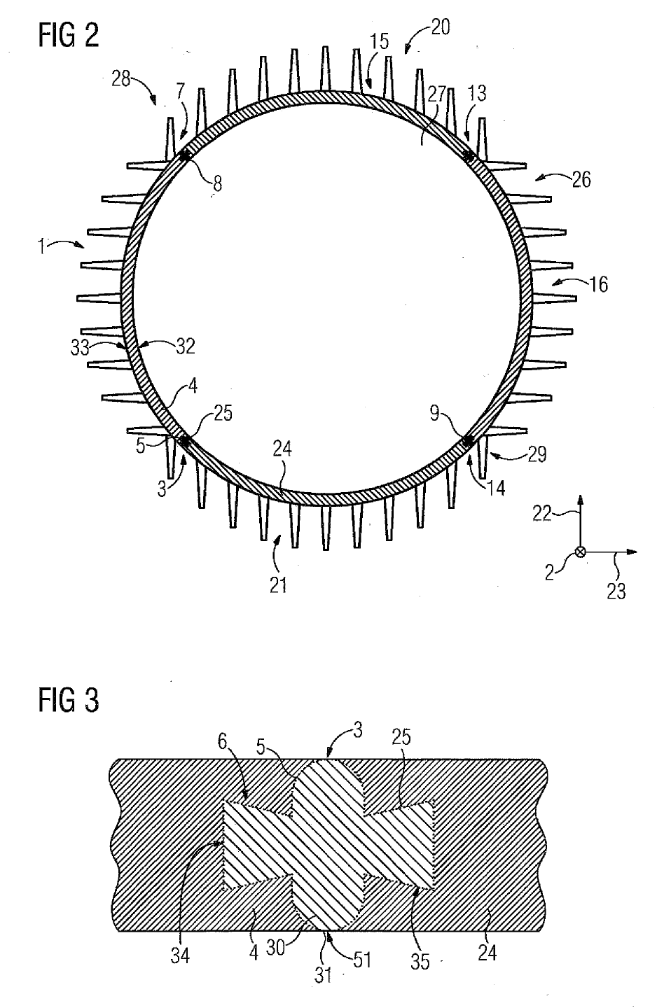

FIG. 2 a section through a cross-sectional plane of an exemplary embodiment of a segmented component,

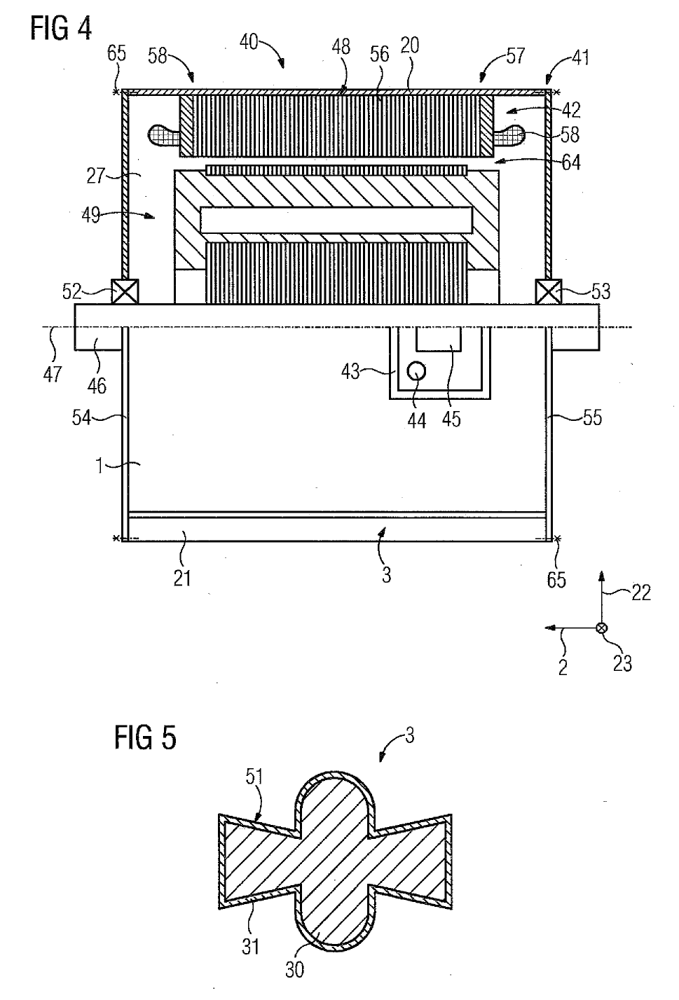

FIG. 3 a detail of the exemplary embodiment of the segmented component according to FIG. 2,

FIG. 4 shows a half view and a half section of an exemplary embodiment of a machine,

FIG. 5 an exemplary embodiment of a shaped part,

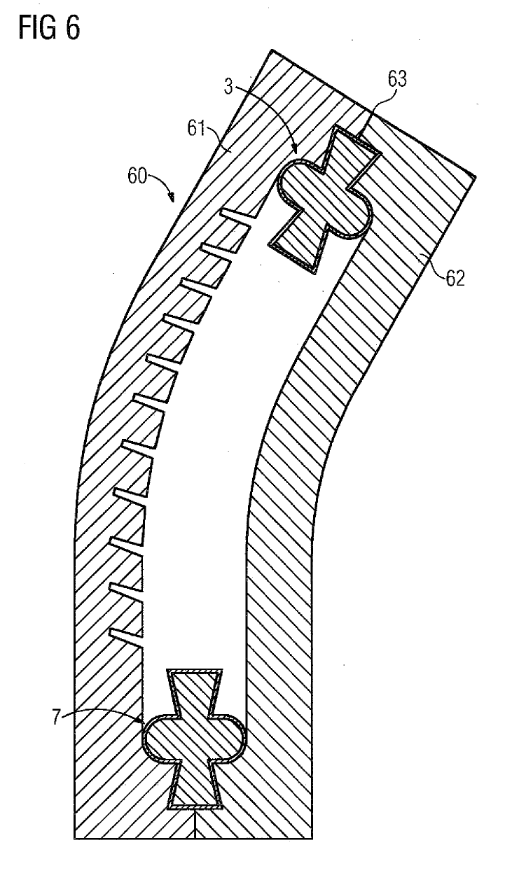

FIG. 6 an exemplary embodiment of a first casting mold for an exemplary embodiment of a method for manufacturing a segmented component,

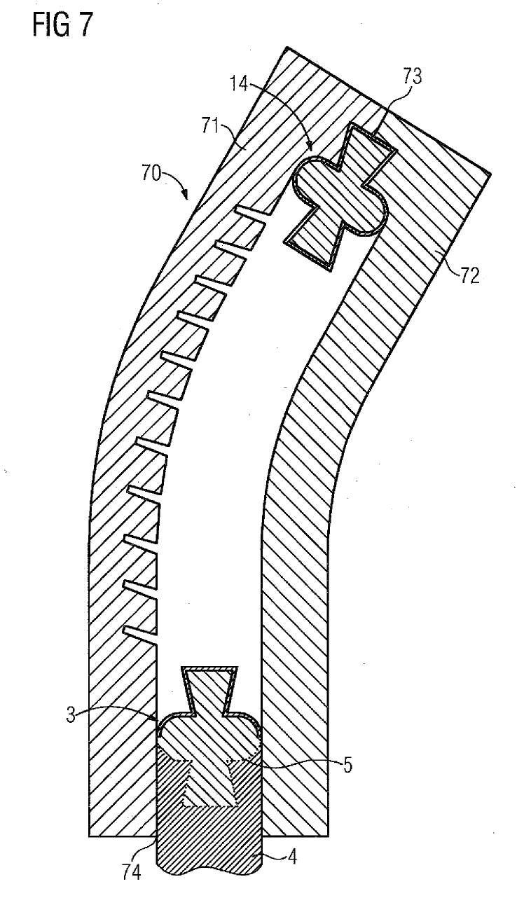

FIG. 7 an exemplary embodiment of a second casting mold for the exemplary embodiment of a method for manufacturing a segmented component.

FIG. 1 shows a section through a cross-sectional plane of an exemplary embodiment of a segment 1 with a shaped part 3. The cross-sectional plane is spanned at a particular axial position in an axial direction 2 by a first radial direction 22 and a second radial direction 23. The segment 1 is a first segment 1 and the shaped part 3 is a first shaped part 3, wherein the first cast metal region 4 of the first segment 1 is material-bonded to the first shaped part 3 by means of a first bonding zone 5. The first segment 1 extends in an axial direction 2 which runs vertically to the cross-sectional plane of the segment 1. The segment 1 with the shaped part 3 has an extension on the cross-sectional plane which extends from a first end, at which the first shaped part 3 is located, to a second end at which an additional shaped part 7 is located. The additional shaped part 7 is material-bonded to the first segment 1 by a fourth bonding zone 8. The segment 1 with the shaped part 3 has a coating 31,11 on the exposed surfaces of the first shaped part 3 and the additional shaped part 7. The segment 1 with the shaped part 3 essentially has the same basic shape on all the cross-sectional planes of the segment 1 in an axial direction 2. The basic shape is determined by a parallel arrangement in an essentially axial direction 2 of an edge 10 of the additional shaped part 7 and an edge 12 of the first shaped part 3. in a high quality The first segment 1 can thus be economically advantageously bonded to additional segments without having to pay too much attention to the avoidance of a twisted construction.

An external surface 19 and an internal surface 18 of the first segment 1 which have an extension in an axial direction 2 and an extension between the first end (at which the first shaped part 3 is located) and the second end (at which an additional shaped part 7 is located), can economically advantageously have a different shape in a high quality by means of casting, in particular by means of pressure die-casting, of the first cast metal region 4 on various cross-sectional planes of the segment 1 with the shaped part 3. The cast metal region 4 can thus have fins 36 on an external surface 19 of the segment 1.

FIG. 2 shows a section through a cross-sectional plane of an exemplary embodiment of a segmented component 20 for a housing 41. The segmented component 20 for the housing 41 comprises the first segment 1 and a second segment 21, wherein the first segment 1 and the second segment 21 extend in an axial direction 2 running vertically to the cross-sectional plane of the segmented component 20. The segmented component 20 has the first shaped part 3 which extends in an axial direction 2, wherein the first segment 1 has a first cast metal region 4. The second segment 21 has a second cast metal region 24. The first cast metal region 4 is material-bonded to the first shaped part 3 by the first bonding zone 5. The first shaped part 3 is material-bonded to the second cast metal region 24 by means of a second bonding zone 25. In the exemplary embodiment of the underlying component 20, the first segment 1 consists of the first cast metal region 4 and the second segment 21 consists of the second cast metal region 24. The two additional segments of the segmented component 20 shown in FIG. 2 also consist of cast metal regions. All the cast metal regions are manufactured from aluminum or an aluminum alloy by means of pressure die-casting.

The segmented component 20 indicates an extension of an interior space 27 of the housing 41 on the cross-sectional plane of the housing 41 by means of the first segment 1, the first shaped part 3, the second segment 21 and an additional element 26, wherein the additional element 26 is material-bonded to the second segment 21 by a third bonding zone 9 and is material-bonded to the first segment 1 by a fourth bonding zone 8. In the exemplary embodiment of the segmented component 20, the additional element 26 consists of an additional segmented component 13,15,16 and two additional shaped parts 7,14, wherein one 7 of the additional shaped parts 7,14 is material-bonded to the first segment 1 by the fourth bonding zone 8 and the second 14 of the additional shaped parts 7,14 is material-bonded to the second segment 21 by the third bonding zone 9. One 7 of the additional shaped parts 7,14 is material-bonded to an additional segment 15 by a fifth bonding zone at a first end 28 of the additional segmented components 13,15,16 and the second 14 of the additional shaped parts 7,14 is material-bonded to an additional segment 16 by a sixth bonding zone at a second end 29 of the additional segmented components 13,15,16. The first end 28 and the second end 29 relate to an extension of the additional segmented components 13,15,16 on the cross-sectional plane of the additional segmented component according to the invention 13,15,16. The first segment 1 and the second segment 21 determine the shape of the segmented component 20 on the cross-sectional plane between a first end 28 and a second end 29 of the segmented component 20 for the housing 41. All the shaped parts 3,7,13,14 of the segmented component 20, i.e. the first shaped part 3, the additional shaped part 7,14 and a shaped part of the additional segmented components 13,15,16 have the same shape and the same dimensions and were manufactured in large quantities in a manufacturing process. FIG. 2 shows a section through the cross-sectional plane through the first radial direction 22 and the second radial direction 23 at a particular position in an axial direction 2. On the cross-sectional plane of the segmented component 20, forces between the first segment 1 and the second segment 21 can mainly be absorbed by the first cast metal region 4. The forces can engage in the first cast metal region 4 in a direction resulting from a combination of the axial direction 2, the first radial direction 22 and the second radial direction 23. Between the first segment 1 and the second segment 21 forces may occur as the difference between various forces which engage in the first segment 1 and the second segment 21. In the exemplary embodiment of the segmented component 20, the forces between the first segment 1 and the second segment 21 can be absorbed by the first cast metal region as the cast metal region 4 extends from an external surface 33 of the segmented component 20 to an internal surface 32 of the segmented component 20. The first cast metal region 4 can mainly absorb the forces between the first segment 1 and the second segment 21 if the first cast metal region 4 extends over the majority of a section between the external surface 33 of the segmented component 20 and the internal surface 32 of the component 20. On the cross-sectional plane of the segmented component 20, forces between the first segment 1 and the second segment 21 can mainly be absorbed by the first shaped part 3. The first shaped part 3 mainly fills a section between the external surface 33 and the internal surface 32 of the segmented component 20 for this. In the exemplary embodiment according to FIG. 2, the first segment 21 is only bonded to the second segment 21 by way of the shaped part 3. Thus, the first shaped part 3 advantageously absorbs forces on the cross-sectional plane of the segmented component 20 between the first segment 1 and the second segment 21 and a force-transmitting bonding property can be economically advantageously set in a high quality between the first segment 1 and the second segment 21. Due to the better elasticity of the first shaped part 3 compared to the cast metal regions of the segments 1, 21, 15, 16 of the segmented component 20, it is economically advantageously possible in a high quality to fix a stator of a machine according to the invention in the segmented component 20. As a result of the better elasticity of the first shaped part 3, the stator in the interior 27 of the housing 41 or of the segmented component 20 can be economically fitted in a high quality and a better frictional bond thus achieved between the stator and the segmented component 20 or the housing 41. Consequently, in the exemplary embodiment of FIG. 2 a force-transmitting bonding property is advantageously adjusted between the first 1 and the second segment 21, or between two segments of the segmented component 20 at a time as a result of the greater elasticity of the first shaped part 3 compared with the cast metal regions.

FIG. 3 shows a detail of the exemplary embodiment of the segmented component 20 according to FIG. 2. The detail shows a region around the first shaped part 3 in an enlarged representation. The first cast metal region 4 is cast from the first material by means of pressure die-casting. In the first bonding zone 5 the first shaped part 3 is melted by the first material. The first shaped part 3 has a second material which includes aluminum. The first bonding zone 5 has an alloy, wherein the alloy includes the first and the second material. The first shaped part 3 has a third material in a region 30 adjacent to the first bonding zone 5. The third material in the exemplary embodiment of the segmented component 20 is copper. The adjacent region 30 extends in an interior part of the first shaped part 3 which is surrounded by a coating on the surface 51 of the first shaped part 3 before casting of the first cast metal region 4 and the second cast metal region 24. Along a section of the bonding zone 5, there is a form closure 6 between the first cast metal region 4 and the first shaped part 3. The form closure 6 extends along at least half the length of the bonding zone 5, wherein the length of the bonding zone 5 is measured along a transition area 34 of the first shaped part 3 on a side facing the first cast metal region 4 on the cross-sectional plane. The form closure 6 has a dovetail groove in the first cast metal region 4 and a dovetail spigot on the first shaped part 3. The first shaped part 3 has side facing the second cast metal region 24 which is material-bonded to the second cast metal region 24 by the second bonding zone 25. The second cast metal region 24 is cast from the first material by means of pressure die-casting. In the second bonding zone 25 the first shaped part 3 is melted by the first material. The second bonding zone 5 has an alloy, wherein the alloy includes the first and the second material. In the exemplary embodiment of the segmented component 20, the remainder of the coating 31 is found between the first bonding zone 5 and the second bonding zone 25 on the surface 51 of the first shaped part 3. The coating can protect the shaped part on the external surface 33 and on the internal surface 32 of the segmented component 20 against environmental influences. The remainder of the coating 31 is still present on the external surface 33 and on the internal surface 31 as in this exemplary embodiment of the cast metal region 20 the first material could not melt at these points of the first shaped part.

FIG. 4 shows a half-view and half a section of an exemplary embodiment of a machine 40. The half section is above an axis of rotation 47. The machine comprises the housing 41 with the segmented component 20, wherein the machine 40 has a stator 42 which is frictionally fixed in the segmented component 20 by way of a frictional bond between at least one surface 48 on an outer periphery of the stator 42 and an internal surface 32 of the segmented component 20 for the operation of the machine 40. The stator 42 has a basic shape which extends along the axial direction 2, wherein the axial direction 2 extends vertically to a base area of the basic shape. The basic shape can be reproduced by means of parallel movement of the base area along the axial direction 2. The basic shape of the outer periphery of the stator 42 can be reproduced by means of a contour of the base area with parallel movement of the base area along the axial direction 2. When operating the machine 40, a rotor 49 is rotated around the axis of rotation 47 which extends along the axial direction 2 and mechanical energy can be emitted to a mechanical consumer in the form of a rotary motion on a shaft 49 to which the rotor 49 is fastened. The forces occurring as a result lead to counterforces in the stator 42 which is fastened in the segmented component 20. When operating the machine 40, mechanical energy can also be supplied to the machine 40 by way of the shaft 46, also leading to corresponding counterforces on the stator 42. In the case of the machine 40, the shaft 46 is mounted in a first bearing shield 54 with the aid of a first bearing device 52 and in a second bearing shield 55 with the aid of a second bearing device 53. The first bearing shield 54 and the second bearing shield 55 determines an extension of the housing 41 in the axial direction 2. The first bearing shield 54 and the second bearing shield 55 are fastened to the axial ends of the segmented component 20.

Especially advantageously, an electric machine 40 can be economically advantageously provided in a high quality according to the invention. When operating the electric machine 40 as a generator, the rotor 49 is rotated by means of mechanical energy around the axis of rotation 47 which extends along the axial direction 2. By means of magnetic interaction between the rotor 49 and the stator 42, the mechanical energy can be converted into electric energy. The electric energy can be taken on a coil 50 which is fastened to the stator 42 for an electric consumer. During the operation of an electric machine 40 according to the invention as a motor, electric energy is supplied by way of the coil 50 and electric energy converted into mechanical energy by means of the magnetic interaction between the stator 42 and the rotor 49. The rotor 49 is rotated around the axis of rotation 47 and mechanical energy can be emitted on a shaft 46 to a mechanical consumer in the form of a rotary motion. The rotor 49 is fastened to the shaft 46. Advantageously, in the case of an electric machine according to the invention, the stator 42 can be economically pressed into the interior 27 of the housing 41 or the segmented component 20 in a high quality by means of the better elasticity of the first shaped part 3 with few changes to the properties of the stator 42 responsible for the magnetic interaction of the stator with the rotor. In addition, pressure die-casting can advantageously strengthen these advantages as a result of greater precision of the dimensions of the interior 27.

The stator 42 has a laminated core which comprises layered plates 56 in the axial direction 2 from a first axial end 57 to a second axial end 58 of the stator 42. The layered plates 56 in the axial direction 2 serve to guide the magnetic flow during operation of an electric machine 40. The rotor 49 has a facility to enable magnetic interaction by way of the air gap 64 with the stator 42, in particular with the coil fastened on the stator 42. In the exemplary embodiment of the electric machine 40 the facility is a shading coil which has a conductor of a second material comprising copper. The rotor 49 of the electric machine 40 is therefore a cage rotor. The first bearing shield 54 and the second bearing shield 55 are fastened at the axial ends of the segmented component 20. In the exemplary embodiments, the first bearing shield 54 and the second bearing shield 55 are fastened at the axial ends of the segmented component 20 with screws 65 as fastening elements.

A half view of the electric machine 40 from the outside can be seen below the axis of rotation 47 in FIG. 4. The external surfaces of the first segment 1 and the second segment 21, and the first shaped part 3 can be seen. The external surface of the machine 40 thus has fins 36 as cooling fins which are components of the first segment 1 and the second segment 21. The fins 36 are not shown in FIG. 4. In FIG. 4 it can be seen that the first segment 1 has walls 43 of a terminal box, a bore 44 and an opening 45 into the interior 27 of the electric machine 40. The bore 44 is for fastening terminal box elements. The walls 43 of the terminal box, the bore 44 and the opening 45 are connected in one piece to the segment 1. The segment 1, the walls 43 of the terminal box, the bore 44 and the opening 45 are manufactured in one piece by means of pressure die-casting.

FIG. 5 shows an exemplary embodiment of a shaped part, wherein the shaped part is the first shaped part 3. A deformation process was used to manufacture the first shaped part 3, for example, extrusion, to obtain the appropriate shape of the first shaped part 3. As a result of the deformation process, the first shaped part 3 has a finer structure compared with the cast metal regions. The first shaped part 3 primarily consists of a third material, which in the exemplary embodiment is copper. An additional material is applied to the surface 51 of the first shaped part 3 by means of coating with a coating method, as described in the patent application with the publication number EP 2396872 A1 for conductors of a second material. The first shaped part 3 has a metallic coating 31 with the additional material. Thus, the first bonding zone 5 of the exemplary embodiment of the segmented component 20 or the segment 1 with the shaped part 3 may include an alloy, wherein the alloy includes the first material and a second material, wherein the second material is the additional material. The coating 31 of the first shaped part 3 encloses an inner area which is made from one piece of a material which was used as the starting point for manufacturing the first shaped part 3. The first shaped part 3 thus primarily consists of this material, which in the exemplary embodiment is copper. This material is the third material. In the exemplary embodiment of the segmented component 20 or the segment 1 with the shaped part 3, the inner area essentially corresponds to that of the area 30 adjacent to the first bonding zone 5.

FIG. 6 shows an exemplary embodiment of a first casting mold 60 for an exemplary embodiment of a method for manufacturing a segmented component 20. In such an exemplary embodiment, for the manufacturing of a segment with a shaped part the first shaped part 3 and an additional shaped part 7 are inserted into the first casting mold 60. Then to cast the first cast metal region, a free space remaining after the insertion of the first shaped part 3 and the additional shaped part 7 is filled with the first material by means of pressure die-casting. In the exemplary embodiment of the first casting mold 60 according to FIG. 6, after the separation of a first half 61 of the first casting mold 60 from a second half 62 of the first casting mold 60, the segment with the shaped part can be removed at a separating point 63. With the aid of the first casting mold 60 a segment with a shaped part, which in each case has a shaped part at all the connection points for connection to the second and additional segments, can thus be economically advantageously manufactured in a high quality.

FIG. 7 shows an exemplary embodiment of a second casting mold 70 for the method for manufacturing a segmented component 22. For this purpose, an additional shaped part 14 and a segment with the first cast metal region 4 and the first shaped part 3 are inserted into the second casting mold 70, wherein the cast metal region 4 only partially projects into the second casting mold 70 at an opening 74 to the first shaped part 3. To cast the second metal region 24 a remaining free space in the second casting mold 70 is filled with the first material by means of pressure die-casting. In the exemplary embodiment of the second casting mold 70, after the solidifying of the first material by means of separation of the first half 71 of the second casting mold 70 from the second half 72 of the second casting mold 70 at a separating point 73, a segmented component comprising a first segment with the cast metal region 4 and a second segment with a second cast metal region, and three shaped parts 7, 3 and 14 can be removed. Advantageously, additional segments can be added to the segmented component by means of additional procedural steps using the second casting mold 70 as described. For closed components such as, for example, the segmented component 20 according to FIG. 2 for the housing 41 of a machine 40 according to FIG. 4, in a method for manufacturing a segmented component two open ends of the segmented component 20, each having a shaped part, are inserted into a third casting mold and an additional segment manufactured by filling the remaining free space in the casting mold by means of pressure die-casting. The segments and shaped parts of the component thus manufactured indicate an extension of an interior space of a housing on a cross-sectional plane of the housing. Advantageously economically in a high quality, the first casting mold, the second casting mold and if applicable, a third casting mold need only have the dimensions sufficient for manufacturing segments.

Although the invention was described in more detail by the preferred exemplary embodiments, it is not restricted by the disclosed examples and other variations can easily be derived by a person skilled in the art without departing from the scope of the invention.

What is claimed is:

1.-16. (canceled)

17. A segmented component for a housing, comprising:
a first shaped part;
a first segment having a first cast metal region, said first cast metal region being material-bonded to the first shaped part by a first bonding zone;
a second segment having a second cast metal region, said first shaped part being material-bonded to the second cast metal region by a second bonding zone; and
at least one additional element material-bonded to the second segment by a third bonding zone and material-bonded to the first segment by a fourth bonding zone,
wherein the first shaped part, the first and second segments, and the at least one additional element define an extension of an interior space of the housing in a cross-sectional plane.

18. The segmented component of claim 17, wherein the first cast metal region is cast from a first material, said first shaped part being fused in the first bonding zone by the first material.

19. The segmented component of claim 17, wherein the first cast metal region is cast from the first material by pressure die-casting.

20. The segmented component of claim 18, wherein the first shaped part has a second material and the first bonding zone has an alloy which contains the first and second materials.

21. The segmented component of claim 20, wherein the first and second cast metal regions are made of aluminum or an aluminum alloy by pressure die-casting, said second material containing aluminum.

22. The segmented component of claim 17, wherein the first shaped part has a third material in a region adjacent to the first bonding zone.

23. The segmented component of claim 22, wherein the third material is copper.

24. The segmented component of claim 17, wherein the first cast metal region and the first shaped part are joined by a form closure along a section of the first bonding zone.

25. The segmented component of claim 17, wherein the first shaped part has a side which faces the first cast metal region and has a structure for enlargement of a transition area of the first shaped part.

26. The segmented component of claim 17, wherein the first and second segments establish a shape of the segmented component in a cross-sectional plane between first and second ends of the segmented component.

27. The segmented component of claim 17, wherein the first and second segments establish a shape of the segmented component in a cross-sectional plane between first and second ends of the segmented component through the first and second cast metal regions.

28. The segmented component of claim 17, wherein the first and second cast metal regions establish a shape of the segmented component in a cross-sectional plane of the segmented component.

29. The segmented component of claim 17, wherein the at least one additional element represents a second shaped part.

30. The segmented component of claim 17, wherein the at least one additional element includes at least one further segment, which has a cast metal region, and at least two further shaped parts.

31. A machine, comprising:
a segmented component for a housing, said segment component including a first shaped part, a first segment having a first cast metal region, said first cast metal region being material-bonded to the first shaped part by a first bonding zone, a second segment having a second cast metal region, said first shaped part being material-bonded to the second cast metal region by a second bonding zone, and at least one additional element material-bonded to the second segment by a third bonding zone, and material-bonded to the first segment by a fourth bonding zone, wherein the first shaped part, the first and second segments, and the at least one additional element defining an extension of an interior space of the housing in a cross-sectional plane; and
a stator frictionally fixed in the segmented component by a frictional bond between at least one surface on an outer periphery of the stator and an internal surface of the segmented component for operation of the machine.

32. A method for manufacturing a segmented component for a housing, comprising:
material-bonding a first cast metal region of a first segment to a first shaped part of the segmented component by a first bonding zone;
material-bonding a second cast metal region of a second segment to the first shaped part by a second bonding zone;
connecting two open ends of the segmented component in a casting mold by a material-bond through casting of the cast metal regions; and
material-bonding at least one additional element to the second segment by a third bonding zone and to the first segment by a fourth bonding zone such that the first and second segments, the first shaped part, and the at least one additional element define an extension of an interior space of the housing in a cross-sectional plane of the housing.

33. A method of using a shaped part for a segmented component for a housing, said method comprising:
material-bonding the shaped part to a first cast metal region of a first segment by a first bonding zone;
material-bonding the shaped part to a second cast metal region of a second segment by a second bonding zone; and
material-bonding at least one additional element to the second segment by a third bonding zone and to the first segment by a fourth bonding zone such that the shaped part, the first and second segments, and the at least one additional element define an extension of an interior space of the housing in a cross-sectional plane of the housing.
